(19) United States
(12) Patent Application Publication
(10) Pub. No.: US 2009/0049751 A1
(43) Pub. Date: Feb. 26, 2009

(54) Anti-tilting, pivotable, sliding panels

(76) Inventor: Samir El Jalkh, Beirut (LB)

Correspondence Address: HARRINGTON & SMITH, PC, 4 RESEARCH DRIVE, Suite 202, SHELTON, CT, 06484-6212, US

(21) Appl. No.: 12/288,661

(22) Filed: Oct. 22, 2008

Related U.S. Application Data
(63) Continuation-in-part of application No. 11/190,282, filed on Jul. 26, 2005.
(60) Provisional application No. 60/602,387, filed on Aug. 17, 2004.

(51) Int. Cl. E05D 15/48; E06B 3/50

(52) U.S. Cl. 49/154; 49/158; 49/506

(57) ABSTRACT

Disclosed herein is a panel movement system. The panel movement system includes top and bottom rails, top and bottom rail attachments, and a gear movement system. The top and bottom rails include threaded screw members along their lengths and first cog members rotatively coupled to the threaded screw members. The top and bottom rail attachments are movably attached to respective ones of the rails for lateral movement along lengths of the rails. Each rail attachment includes a rotatable second cog member engaged with the first cog member on respective ones of the rails. The gear movement synchronization system connects the rotatable second cog member of the top rail attachment to the rotatable second cog member of the bottom rail attachment such that the top and bottom rail attachments move along the rails in unison. The top and bottom rail attachments are adapted to have a panel connected therebetween.

### CROSS REFERENCE TO RELATED APPLICATION

This application is a continuation-in-part patent application of U.S. patent application Ser. No. 11/190,282 filed Jul. 26, 2005, which claims the benefit under 35 U.S.C. §119(e) of U.S. provisional patent application No. 60/602,387 filed on Aug. 17, 2004 which are hereby incorporated by reference in their entireties.

### BACKGROUND OF THE INVENTION

1. Field of the Invention

The invention relates to an anti-tilting mechanism for a pivotable, sliding panel made from any rigid material such as glass, wood, or fiber structure intended for use such as on balconies, verandas, piscine, wall separation, etc.

2. Brief Description of Prior Developments

Traditional glazing for balconies or the like consists of a plurality of sash glass panels mounted on upper and lower guide rail and adapted to slide laterally past one another. A major disadvantage with this type of glazing is that at most only 50 percent of the glazed-in area can be opened. Furthermore, the outer surface of the pane is awkward to clean.

Glazing structures have been proposed in which the panes can be stacked against a side wall of the balcony by pivoting about a vertical axis. In WO 89/05389 this is achieved by means of a double upper rail arrangement having a straight outer rail and an inner rail. Within the curved portion of the inner rail the trailing edge of the pane turns inwards and the pane can opened against the side wall of the balcony. Such an arrangement is, however, not particularly aesthetically pleasing and friction can arise in the system and still be a lot of effort to clean

In an effort to eliminate these drawbacks, WO 90/121183 proposes a structure in which the top edge pivot pin of the glass pane is held stationary, no curved guide rail for the trailing edge is required. Whilst eliminating some of the disadvantages of the prior systems, the arrangement according to WO 90/121183 introduces its own drawbacks; one being that the pane must be tilted to disengage the upper trailing wheel from its guide rail before pivoting can commence. Since the leading edge of the pane is locked first only when pivoting has commenced, there is a risk that the trailing wheel may not disengage should the pane topple back before pivoting commences. The fact that the leading edge is locked only once rotation has commenced further implies that a flange protruding from the upper guide rail adjacent the opening for the trailing wheel is required to support the trailing wheel during the initial opening operation. Such protruding flanges hinder the possibility to mount curtains or blinds across the glazing. In addition, because only the upper leading pivot pin is immobilized, the pane cannot be opened through more than 90 degree, due to the fact that the lower leading pivot pin would otherwise be forced along the lower guide rail as a result of the change in position of the center of gravity of the pane.

### SUMMARY OF THE INVENTION

In accordance with one aspect of the invention, a panel movement system is disclosed. The panel movement system includes top and bottom rails, top and bottom rail attachments, and a gear movement system. The top and bottom rails include threaded screw members along their lengths and first cog members rotatively coupled to the threaded screw members. The top and bottom rail attachments are movably attached to respective ones of the rails for lateral movement along lengths of the rails. Each rail attachment includes a rotatable second cog member engaged with the first cog member on respective ones of the rails. The gear movement synchronization system connects the rotatable second cog member of the top rail attachment to the rotatable second cog member of the bottom rail attachment such that the top and bottom rail attachments move along the rails in unison. The top and bottom rail attachments are adapted to have a panel connected therebetween.

In accordance with another aspect of the invention, a panel movement system is disclosed. The panel movement system includes a first rail, a first rail attachment, and a gear movement synchronization system. The first rail includes a threaded screw member and a first cog member. The threaded screw member extends along a length of the first rail. The first cog member is rotatively coupled to the threaded screw member. The first rail attachment is movably attached to the first rail for lateral movement along the length of the first rail. The first rail attachment includes a rotatable second cog member engaged with the first cog member on the first rail. The gear movement synchronization system is connected to the rotatable second cog member of the first rail attachment. The first rail attachment is configured to be connected to a first side of a panel. The first rail attachment includes a top and a bottom roller located on opposite sides of the first rail.

In accordance with another aspect of the invention, a method of manufacturing a movable panel system is disclosed. Top and bottom movement systems are connected to top and bottom ends of a panel. The top and bottom movement systems each include a rotatable gear member. The movement systems are connected to respective top and bottom rails such that the movement systems can traverse along the rails. Threaded screw members are connected adjacent to the top and bottom rails. The threaded screw members extend along lengths of the rails. First cog members are rotatively coupled to the threaded screw members. The rotatable gear members of the top and bottom movement systems are engaged with the first cog members. The top and bottom movement systems operate in registration with each other and traverse along the rails in unison with each other.

### BRIEF DESCRIPTION OF THE DRAWINGS

The foregoing aspects and other features of the invention are explained in the following description, taken in connection with the accompanying drawings, wherein:

FIG. 1 is a perspective view of a movable panel assembly incorporating features of the invention;

FIG. 2 is a perspective view of a portion of one of the rails of the frame of the assembly shown in FIG. 1;

FIG. 3 is a perspective view of components of the assembly shown in FIG. 1;

FIG. 4 is another perspective view of components of the assembly shown in FIG. 1;

FIG. 5 is a perspective view of the components of the assembly shown in FIG. 4 from an opposite side;

FIG. 6 is a perspective view of the components of the assembly shown in FIG. 4 with a panel attachment of the assembly rotated;

FIG. 7 is a perspective view of the components of the assembly shown in FIGS. 4-6 in a gear box frame;

FIG. 8 is a perspective view of an alternate embodiment of a movable panel assembly incorporating features of the invention;

FIG. 9 is a perspective view of components of the assembly shown in FIG. 8;

FIG. 10 is a perspective view of the components of the assembly shown in FIG. 8 with a panel of the assembly rotated;

FIG. 11 is a perspective view of another alternate embodiment of a movable panel assembly incorporating features of the invention;

FIG. 12 is a perspective view of components of the assembly shown in FIG. 11; and

FIG. 13 is a perspective view of the components of the assembly shown in FIG. 11 with a panel of the assembly rotated.

### DETAILED DESCRIPTION OF THE PREFERRED EMBODIMENTS

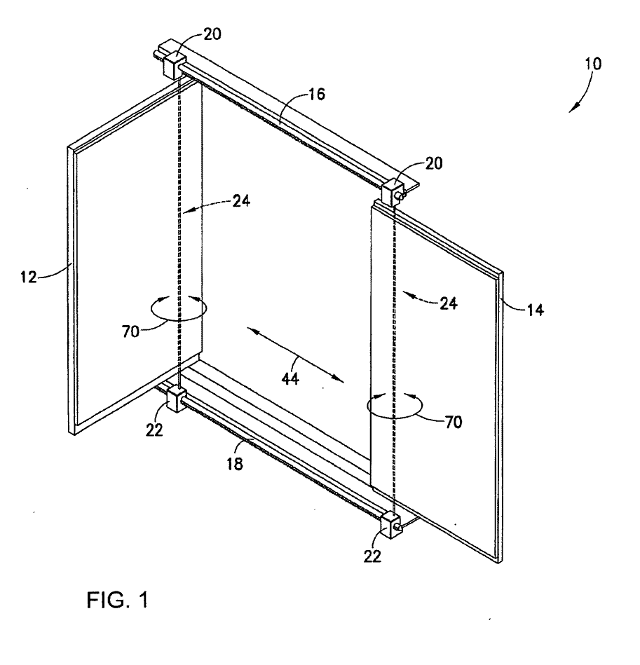

Referring to FIG. 1, there is shown a perspective view of a movable panel assembly 10 incorporating features of the invention. Although the invention will be described with reference to the exemplary embodiments shown in the drawings, it should be understood that the invention can be embodied in many alternate forms of embodiments. In addition, any suitable size, shape or type of elements or materials could be used.

The panel assembly 10 in this embodiment is a window or glass door for use in a building. However, in alternate embodiments the invention could be used in any suitable type of assembly where panels are intended to be moved relative to each other. The assembly 12 comprises two panels 12, 14 which are window panes. Non-window panels could be provided. More or less than two movable panels could be provided. The assembly 12 also comprises a frame with two rails 16, 18, top and bottom movement sections 20, 22 for each panel 12, 14, and a synchronization system 24 for each panel 12, 14.

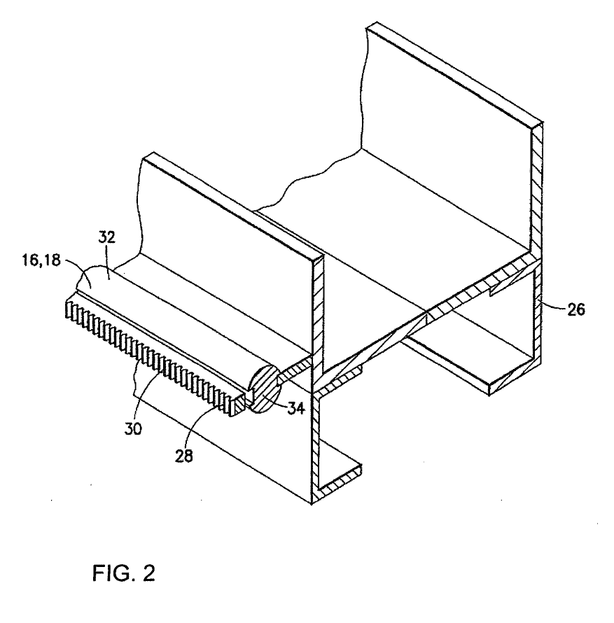

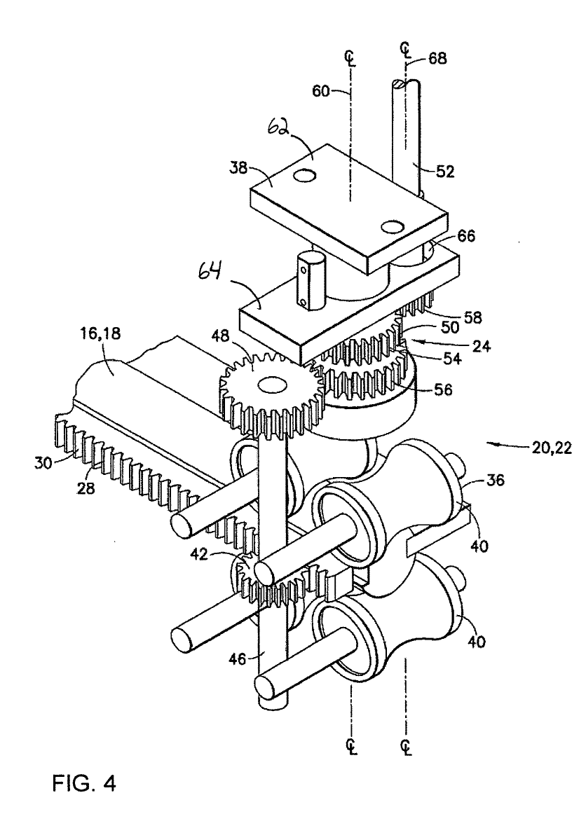

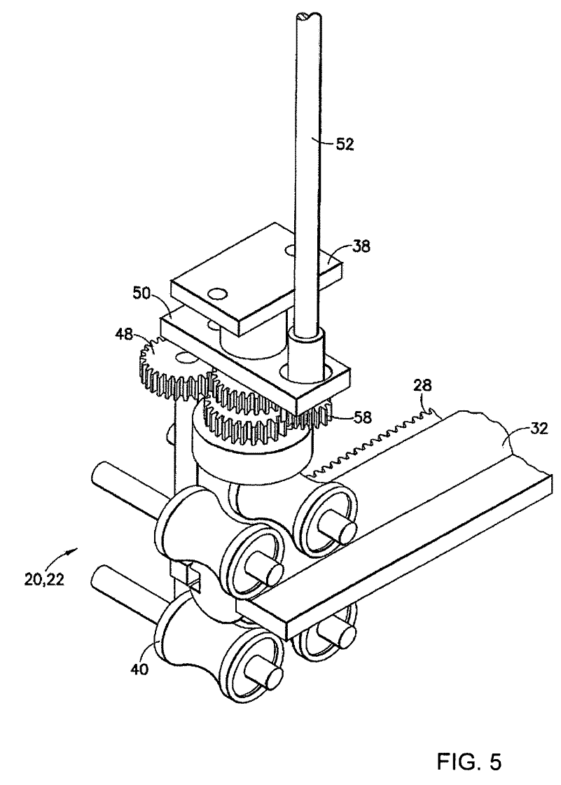

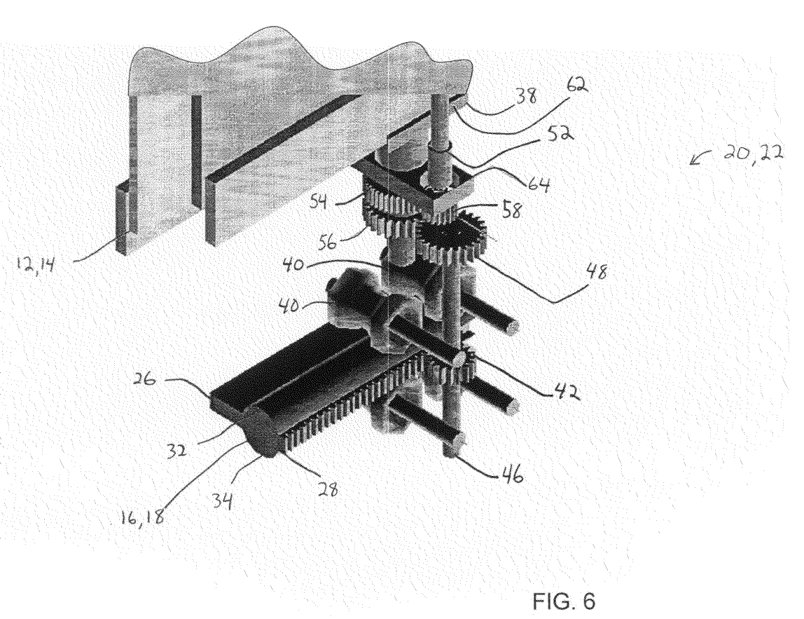

Referring also to FIG. 2, the two rails 16, 18 are identical to each other. In alternate embodiments the rails could be different. The rails 16, 18 extend in a general cantilever fashion from the frame 26. As shown in FIG. 2, the rails 16, 18 may comprise a groove section for receiving or fitting a portion of the frame 26 therein. This provides for a cantilever fixing of the rails 16, 18 to the frame 26. However, in alternate embodiments any suitable configuration for attaching the rail 16, 18 to the frame 26 may be provided. Preferably, the rails 16, 18 extend substantially the entire width of the window. Each rail 16, 18 has a track section with upper and lower convex curved sections 32, 34 and a rack section 28 with registration teeth 30. As shown in FIG. 2, the rails 16, 18 may comprise another groove section for receiving or fitting a portion (opposite the teeth 30) of the rack section 28 therein. However, in alternate embodiments any suitable configuration for attaching the rack section 28 to the rail 16, 18 may be provided. Referring also to FIGS. 4-6, the top and bottom movement systems 20, 22 are identical to each other, but reversely oriented or flipped relative to each other. In alternate embodiments the movement sections could be different from each other. Each panel 12, 14 has the pair of the movement sections 20, 22 attached to its top and bottom ends. The top movement sections (or upper synch gear boxes) 20 are mounted on the top rail (or upper guide rail) 16 and the bottom movement sections (or lower synch gear boxes) 22 are mounted on the bottom rail (or lower guide rail) 18.

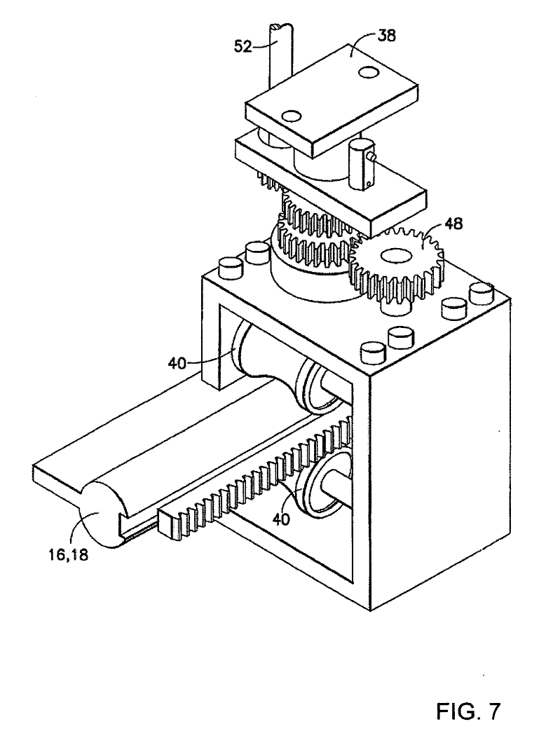

Each movement section 20, 22 comprises a rail attachment 36, a panel attachment 38 and part of the synchronization system 24. The rail attachment 36 comprises rollers 40 and a rotatable gear 42. Four rollers 40 are provided; two against the top convex curved section of the rail and two against the bottom convex curved section of the rail. However, in alternate embodiments more or less than two rollers on each top and/or bottom side could be provided. This provides for the panel 12, 14 to be supported on the rails 16, 18 by the rollers 40. The rollers 40 have general cylindrical shape wherein the center is depressed with respect to the edges forming a general concave profile to mate with the convex shapes of the rail sections (or segments) 32, 34. However, in alternate embodiments, any suitable complementary shapes could be provided. The concave profile of the rollers adapts the rollers to slide on the convex rail sections 32, 34 to minimize (or substantially eliminate) any sideways movement and/or noise motion of the rollers. The rollers are attached by shafts to a gear box frame (or body) of the movement sections 20, 22. With the rollers 40 attached and fixed to the gear box frame (best shown in FIG. 7), this ensures that the rollers 40 (and the panel 12, 14) stay in place concerning vertical movement. The rollers 40 are able to rotate to roll the movement sections 20, 22 along the rails 16, 18. This allows the panel 12, 14 mounted to the rails by a pair of the top and bottom movement sections 20, 22 to longitudinally slide along the rails in general lateral directions as indicated by arrow 44 in FIG. 1. The rollers 40 may also transfer the weight of the system onto the rails 16, 18 while providing an easy sliding motion.

The rotatable gear 42 is connected to a rotatable shaft 46. The shaft (or beam) 46 is rotatably mounted to the gear box. An intermediate gear 48 is also connected to the shaft 46. Thus, intermediate gear 48 is rotated when the gear (or cog) 42 is rotated. The gear 42 has its teeth engaged with the teeth 30 of the rack section 28. The gear 42 forms a pinion in a rack and pinion system. When the panel 12, 14 is longitudinally moved along the rail 16, 18, the gear 42 moves along the length of the rack section 28 and rotates because of interaction between the teeth. This causes the gear 48 to rotate.

The panel attachment (or platform) 38 comprises a first section 62 adapted to be directly attached to one of the ends of one of the panels 12, 14. With the panel fixed onto the platform 38 and the platform 38 fixed through several processes to the gear box frame, any horizontal movement made by the gear box frame is transmitted to the panel. The panel attachment 38 also comprises a second section 64 fixedly attached to the first section 62. The second section 64 has a hole 66. A rod 52 of the synchronization system 24 extends through the hole 66. The rod (or synch axe) 52 is rotatably mounted in the hole 66 by a bearing such that the rod can axially rotate in the hole. The axis 68 of rotation of the rod 52 is offset from the axis 60 of rotation of the panel attachment 38. The panel attachment 38 can rotate about the axis 60 relative to the gear box.

Synchronization system 24 includes another intermediate gear 50 and the vertical axially rotatable rod 52. The gear (or cog) 50 is fixed to the gear box for axial rotational movement only about the axis 60. The gear 50 has a top gear section (or cog) 54 and a bottom gear section (or cog) 56. The bottom gear section 56 is engaged with the teeth of the gear (or cog) 48. The top gear section 54 engages teeth of a gear section 58 on the end of the rod 52. The rod 52 has gear sections (or cogs) 58 at both its top and bottom ends.

The rod (or synch beam) 52 provides two different types of movement synchronizations. For each panel 12, 14, the respective rod 52 can help synchronize translation movement of the rail attachments 36 of the top and bottom movement sections 20, 22 relative to each other on their respective top and bottom rail 16, 18. In addition, for each panel 12, 14, the respective rod 52 can help synchronize rotational movement of the panel attachments 38 of the top and bottom movement sections 20, 22 relative to each other.

For synchronized translation movement of the rail attachments 36 of the top and bottom movement sections 20, 22 relative to each other on their respective top and bottom rail 16, 18, the rod acts as a mechanical connection between the movement sections 20, 22. The gears 42 of the two movement sections 20, 22 are connected to each other by the respective intermediate gears 48, 50 of the two movement sections 20, 22 and by the rod 52 and its gears 58 at its opposite ends. Thus, as the gear 42 of the bottom movement section 22 moves along the teeth 30 of the bottom rail 18, the two sets of shafts 46 and gears 48, 50, 58, and the rod 52 insure that the gear 42 of the top movement section 20 moves along the teeth 30 of the top rail 16 in the same direction and with the same amount of movement. Likewise, as the gear 42 of the top movement section 20 moves along the teeth 30 of the top rail 16, the two sets of shafts 46 and gears 48, 50, 58, and the rod 52 insure that the gear 42 of the bottom movement section 22 moves along the teeth 30 of the bottom rail 18. This insures a synchronized movement of the top and bottom ends of the panel 12 or 14 along the width of the window. The panel 12, 14 is, thus, prevented from tilting and perhaps jamming during this lateral translation movement.

The panels 12, 14 can also be individually rotated inward and/or outward as indicated by arrows 70 in FIG. 1. For synchronized rotational movement of the panel attachments 38 of the top and bottom movement sections 20, 22 relative to each other, as the panel attachments 38 are rotated along axis 60 at each of the movement sections 20, 22 the gear 50 can remain stationary. The rod 52, because of its connection at the hole 66 to the panel attachment 38, rotates about the axis 60. The teeth of the gear sections 58 rotate about the perimeter of the top gear section 58 resulting in axial rotation of the rod 52 about its axis 68. Thus, as the panel 12 or 14 is rotated open or closed the gear section 58 at the bottom movement section 22 moves along the teeth of the gear 50 of the bottom movement section 22 and the rod 52 axially rotates to insure that the gear section 58 at the top of the rod at the top movement section 20 moves along the teeth of the gear 50 at the top movement section 20 for the top and bottom panel attachments 38 to move in synchronized unison rotation. The rotational movement can also occur at the same time as translational movement if desired.

The invention can comprise interlocking air-tight panels that are able to slide laterally guided by an upper and a lower rail. As described above, each of the panels follows the movement of the gearbox 20, 22. Wherein the gearbox 20, 22 follows movement of the rollers 40 when the rollers 40 move on the convex segments 32, 34 of the rails 16, 18. The concave profile shape of the rollers 40 allows for horizontal movement. This provides for the panel 12, 14 to follow the rollers 40 movements and move in a horizontal fashion. This can occur with simultaneous pivoting on their axes of rotation 60. This was accomplished by the introduction of specialized gearboxes, located at the extremities of the panels, connecting it to the rails. In order to keep the panel stable while in motion, the gearboxes holding the panels preferably move synchronously else, the panel could be subject to tilting; since one end of the panel may be leading or lagging the other end. The synchronization of the gearbox movements is made possible using a solid beam; the rod 52. The beam 52 connects gear or cog 58 of the lower gearbox with cog 58 of the upper gearbox, enabling them to rotate simultaneously. Rotation of the cog 58 is controlled by a series of other cogs which link it to the rack 28 that lines the rails on which the panel slides aided by the four rollers or pulleys 40.

As the panel is moved laterally, the rack causes pinion 42 to rotate which, in turn, causes the other cogs to rotate relaying rotation to cog 58. Solid beam 52 relays rotation to the upper gearbox. Similarly, the upper gearbox moves the exact distance as that covered by the lower gearbox. The assembly is configured to enable the panels 12, 14 to slide on a horizontal axis while being able to pivot simultaneously on their axis. The assembly is designed to allow those motions all while being free of any tilting motions the panels are prone to while attempting to move them.

When the panel needs to be rotated on its axis 60, one can simply turn the panel by hand. Cog 58 would travel on the perimeter of cog 50, since the panel is fixed on platform 38 which is secured onto axis 60 known as the synch axis, resulting in the rotation of cog 58. This would cause the simultaneous rotation of both cogs, thus maintaining the vertical parallel position of the beam 52 with respect to the panel; avoiding collision of the beam with the panel while in rotation. The end result is a panel, made out of any rigid material, which can be moved laterally guided by rails, while being simultaneously rotated onto its axis. The panel's motion is smooth and easy to move regardless of its weight. With the invention, the panels 12, 14 can also rotate more than 90 degrees; such as 360 degrees for example. In the embodiment described above, the gears 48 only rotate when the panel laterally slides/rolls along the rails. The platform 38 does not rotate with the gear 48. The platform 38 only rotates when the user pivots the panel and rotation of platform 38 causes gear 58 to circle around the gear section 54. The panels 12, 14 can preferably overlap each other when then are slid towards each other, such as more than 50 percent overlap.

The invention comprises a movement and synchronization system having an anti-tilting mechanism and a rotating mechanism which provides for advantages over conventional configurations. For example, in conventional configurations if the top edge of the panel moves faster than the lower edge of the panel, this would result in the panel tilting forwards or backwards (depending on which edge moved faster or traveled a greater distance). To alleviate any possible tilting movements, it is helpful to promote the movement of both edges in unison. The invention provides for movement in unison by configuring the top and bottom movement sections to be connected. As such, when the rollers 40 move forwards on the rails 16 and 18, the rack 28 moves accordingly and causes the gear 42 to rotate. This motion is transmitted sequentially through the gears 48, 56, 54, 58, and finally to rod 52 which is attached to an identical setup on the opposite edge of the panel. This provides for both of the movement sections 20 and 22 to move the same distance and at the same speed when the panel slides horizontally. This implies that the panel does not tilt forwards or backwards while sliding or starting to slide horizontally.

Additionally, the rotating mechanism also provides for advantages over conventional configurations. With the panel 12, 14 fixed on the first section 62 of the platform 38, the second section 64 of the platform 38 keeps the synch beam 52 parallel to the panel 12, 14. The gear 58 relays motion from the gear 54 to the synch beam 52 such that the gear 58 runs on the perimeter of gear 54. When the gear 58 rotates, the synch beam component 52 relays motion to the synch box 20, 22 on the opposite side of the panel 12, 14 causing an identical displacement of the beam on both ends of the panel 12, 14. Also, the synch beam 52 is placed at an offset relative to the panel 12, 14 fixed on the platform 38. This allows two different panels each fixed to their own synch boxes 20, 22 to overlap as much as the design desires to allow the formation of air tight junctions between the adjacent panels 12, 14. This provides for the synch beam 52 to function as a movement relay when it comes to horizontal position and moves out of the panel's 12, 14 way when the panel is rotating, since it is designed to stay parallel to it. Further, offsetting the position of the synch beam 52 relative to the panel's 12, 14 axis allows an air-tight design to be realized if desired.

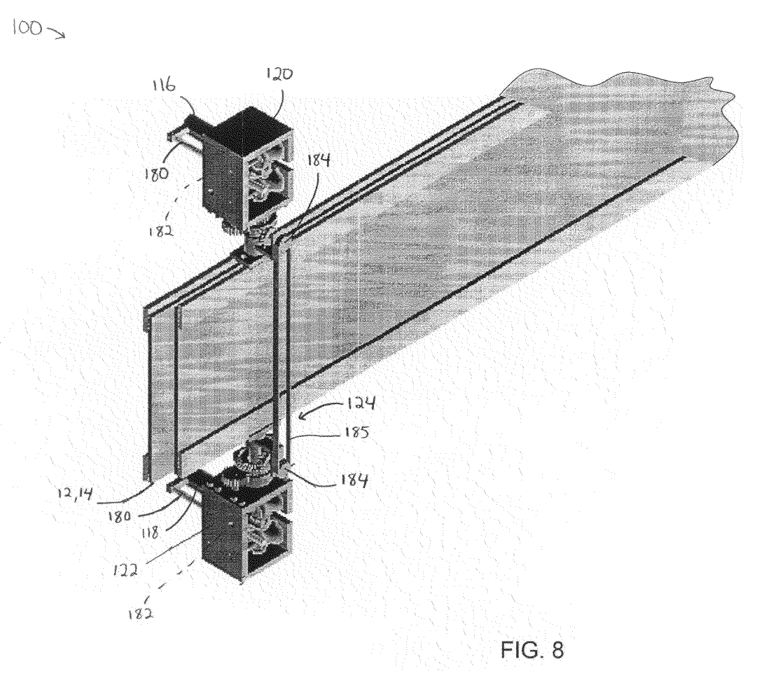

Referring now to FIG. 8, there is shown a perspective view of a movable panel assembly 100 in accordance with another embodiment of the invention. The panel assembly 100 is similar to the panel assembly 10 and similar features are similarly numbered.

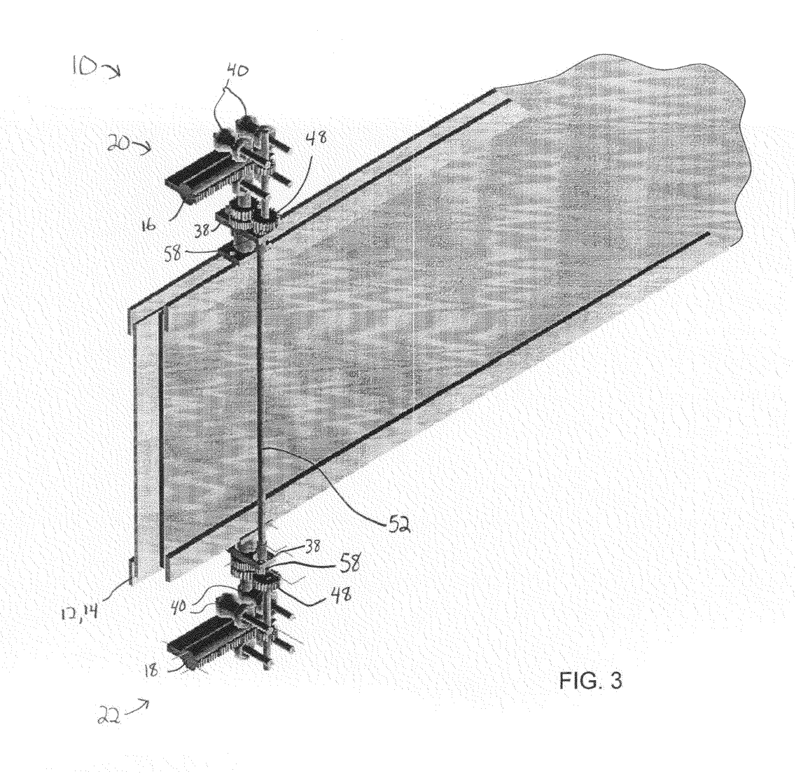

In this embodiment the panel assembly 100 has two panels 12, 14, a frame with two rails 116, 118, top and bottom movement sections 120, 122, and a synchronization system 124 similar to the panel assembly 10 shown in FIGS. 1-7. One difference between the assembly 100 and the assembly 10 is that the movement sections 120, 122 of the assembly 100 comprise a screw 180 and nut 182 arrangement instead of a rack and pinion arrangement. Another difference between the assembly 100 and the assembly 10 is that the synchronization system 124 of the assembly 100 comprises a timing belt 185 connected between the movement sections instead of a rod.

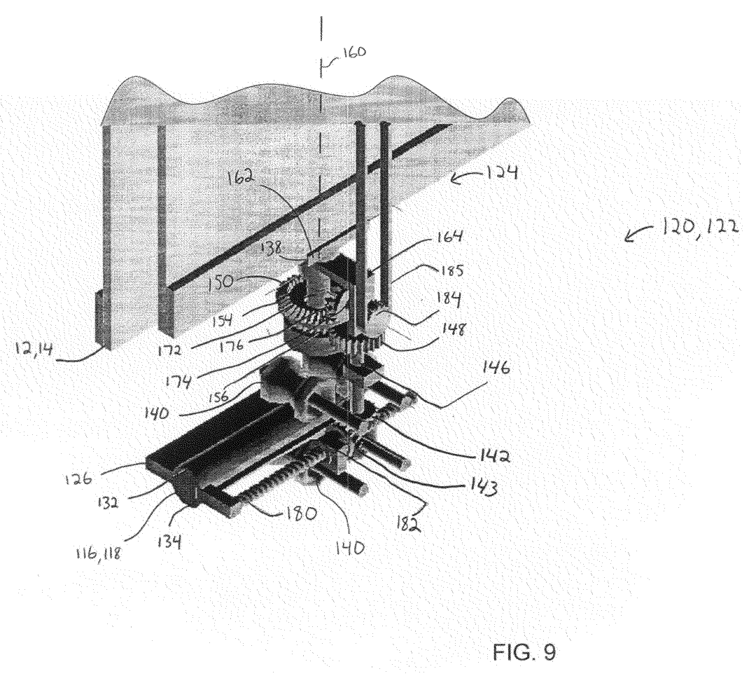

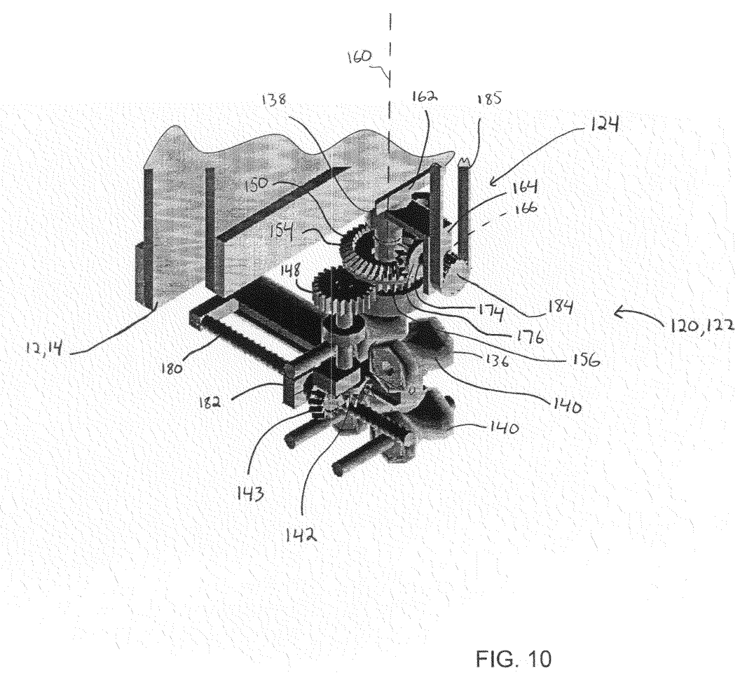

Referring also to FIGS. 9 and 10, the two rails 116, 118 are identical to each other. In alternate embodiments the rails could be different. The rails 116, 118 extend in a general cantilever fashion from the frame 126. Preferably, the rails 116, 118 extend substantially the entire width of the window. Each rail 116, 118 has a track section with upper and lower convex curved sections 132, 134, the free-edged infinite screw 180, and the nut 182 that screws (or threads) on to the screw (or threaded screw member) 180, moving forwards and backwards on the screw 180 registration while rotating simultaneously. The screw 180 extends along the length of the rail 116, 118. The screw 180 may be connected to the rail 116, 118 by cantilevered members extending from the rail 116, 118 such that the screw 180 is substantially parallel to the rail 116, 118. However, any suitable mounting configuration may be provided. Additionally a gear (or gear member) 143, which may be a bevel gear for example, is fixed onto the nut (or threaded nut member) 182. The top and bottom movement systems 120, 122 are identical to each other, but reversely oriented or flipped relative to each other. In alternate embodiments the movement sections could be different from each other. Each panel 12, 14 has the pair of the movement sections 120, 122 attached to its top and bottom ends. The top movement sections 120 are mounted on the top rail 116 and the bottom movement sections 122 are mounted on the bottom rail 118.

Each movement section 120, 122 comprises a rail attachment 136, a panel attachment 138 and part of the synchronization system 124. The rail attachment 136 comprises rollers 140 and a rotatable gear (or gear member) 142. Four rollers 140 are provided substantially the same as the rollers 40 in the panel assembly 10. The rollers are attached by shafts to a gear box frame of the movement sections 120, 122. The rollers 140 are able to rotate to roll the movement sections 120, 122 along the rails 116, 118. This allows the panel 12, 14 mounted to the rails by a pair of the top and bottom movement sections 120, 122 to longitudinally slide along the rails in general lateral (or horizontal) directions substantially the same as described above for the panel assembly 10.

The rotatable gear 142, which may be a bevel gear for example, is connected to a rotatable shaft 146. The shaft 146 is rotatably mounted to the gear box. An intermediate gear 148 is also connected to the shaft 146. Thus, intermediate gear 148 is rotated when the gear (or cog) 142 is rotated. The gear 142 is engaged with the gear (or cog) 143 of the rail 116, 118. This provides for the gear (or cog member) 143 to relay motion between the nut 182 and the gear (or cog member) 142.

The panel attachment 138 comprises a first section 162 adapted to be directly attached to one of the ends of one of the panels 12, 14. The panel attachment 138 also comprises a second section 164 fixedly attached to the first section 162. The second section 164 has a hole 166. A rod 174 extends through the hole 166. The rod 174 relays motion between a gear 176 at one end of the rod 174 and a gear 184 at an opposite end of the rod 174. The rod 174 may be rotatably mounted in the hole 166 by a bearing such that the rod can axially rotate in the hole. However, any suitable mounting configuration may be provided.

The synchronization system 124 includes another intermediate gear 150 and the timing belt 185. The gear 150 is attached to a rod 172 and fixed to the gear box for axial rotational movement only about the axis 160. The gear 150 has a top gear section 154 and a bottom gear section 156. The top gear section 154 and the bottom gear section 156 are fixedly attached to provide for movement in unison. The bottom gear section 156 is engaged with the teeth of the gear 148. This provides for relaying motion between the gear section 156 and the gear 148. The top gear section 154 is engaged with the teeth of the gear 176. The gear 150 is attached to rod 172 such that the rod 172 relays motion between the gear sections 154, 156 and the gear 176. The gear (or cog) 184 engages the timing belt 185 (which may be a water clear urethane timing belt for example). In one embodiment, the cog 184 may comprise teeth which engage with teeth on the timing belt. In another embodiment, the cog 184 may comprise a pulley which engages the belt (such as in a belt and pulley system). However, any suitable configuration may be provided, such as a timing chain configuration for example.

Similar to the rod 52 of the panel assembly 10, the timing belt 185 provides different types of movement synchronizations. The timing belt 185 extends substantially perpendicular to the length of the rail 116, 118 and relays motion between the cog 184 of the lower synch box 122 and the cog 184 of the upper synch box 120. For each panel 12, 14, the timing belt 185 can help synchronize translation movement of the rail attachments 136 of the top and bottom movement sections 120, 122 relative to each other on their respective top and bottom rail 116, 118. When the rollers 140 move forwards or backwards, the nut 182 screws (or threads/registers) on to threads of the screw 180. This causes the nut 182 to move forwards or backwards and rotate along the screw 180. Since the gear (or cog) 143 is fixed on to the nut 182, the nut 182 and the gear 143 both rotate simultaneously (which provides for the nut 182 to be rotatively coupled to the screw 180). This motion is transmitted sequentially through the gear 142, the gear 148, the gear 156, the rod 172, the gear 154, the gear 176, the rod 174, the timing gear 184 and finally to the timing belt 185, which is attached to an identical setup on the opposite edge of the panel 12, 14. However, it should be noted that the movement section on the opposite edge of the panel 12, 14 need not be identical and a different movement section may be provided. The movement described above provides for the movement sections 120, 122 to move the same distance and at the same speed when the panel 12, 14 slides horizontally. This guides the panel so that the panel does not tilt forwards or backwards while sliding or starting to slide (or move) horizontally.

In addition, for each panel 12, 14, the respective timing belt 185 can help synchronize rotational movement of the panel attachments 138 of the top and bottom movement sections 120, 122 relative to each other. The panel 12, 14 is fixed on the section 162. The section 162 is fixed to the section 164. The section 164 comprises a general “L” shape to allow the gear 176 to relay motion to component the gear 154, forming a gear train where the gear 176 runs on the perimeter of the gear 154 when the panel 12, 14 is rotated. When the gear 176 runs on the perimeter of the gear 154, this causes the gear 184 to rotate. In turn, the gear 184 relays motion to the timing belt 185 which relays motion to the same setup on the opposite side of the panel 12, 14. This provides for the timing belt 185 to function as a movement relay when it comes to horizontal position and moves out of the panel's way when the panel is rotating since it is designed to stay parallel to it. However, in alternate embodiments, any suitable configuration may be provided.

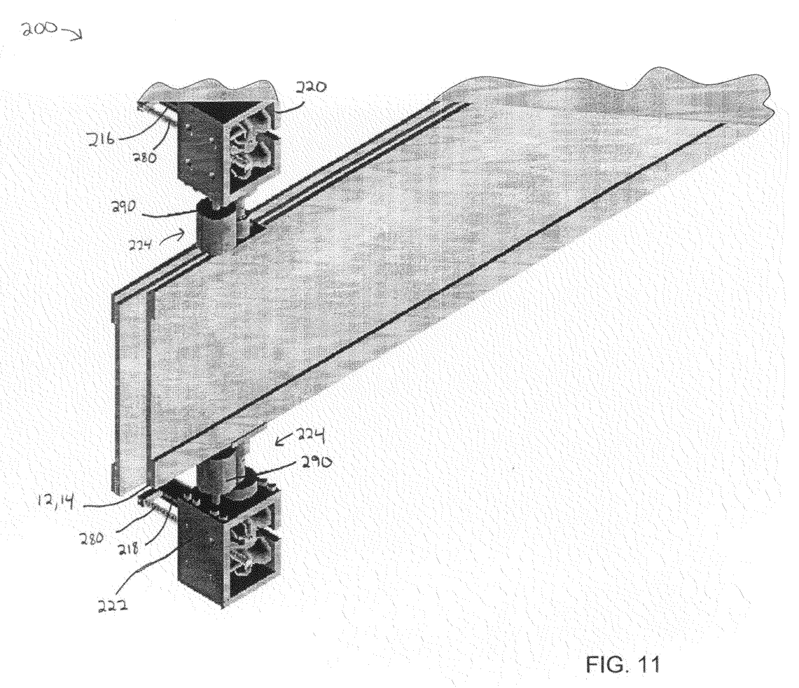

Referring now to FIG. 11, there is shown a perspective view of a movable panel assembly 200 in accordance with another embodiment of the invention. The panel assembly 200 is similar to the panel assembly 100 and similar features are similarly numbered.

In this embodiment the panel assembly 200 has two panels 12, 14, a frame with two rails 216, 218, top and bottom movement sections 220, 222, and a synchronization system 224 similar to the panel assembly 100 shown in FIGS. 8-10. One difference between the assembly 200 and the assembly 100 is that the synchronization system 224 of the assembly 200 comprises a motor 290 connected to the movement sections instead of a timing belt.

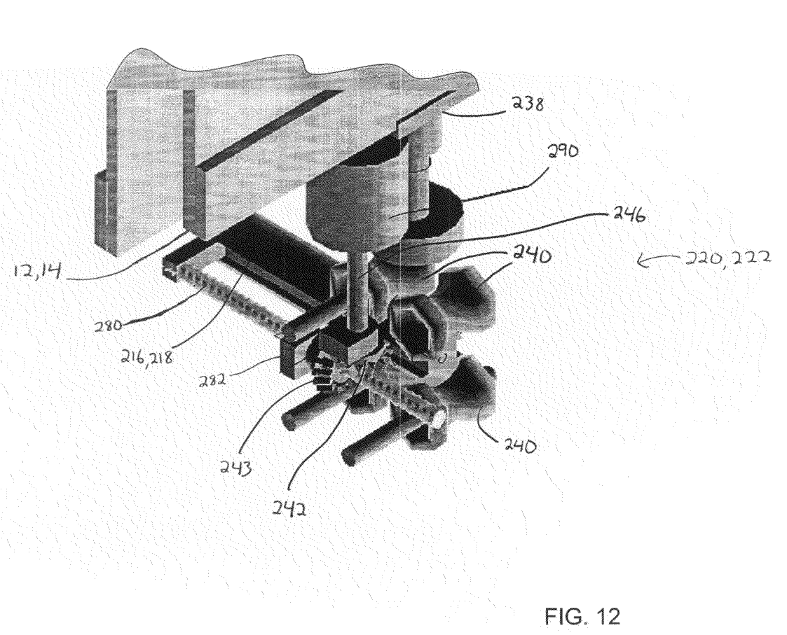

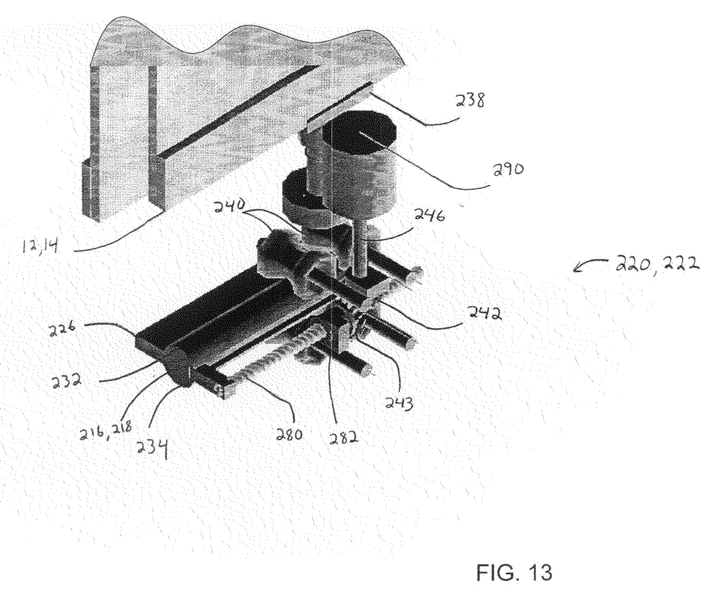

Referring also to FIGS. 12 and 13, the two rails 216, 218 extend from the frame 226 and comprise upper and lower convex curved sections 232, 234, a free-edged infinite screw 280, a nut 282, and a cog (or gear) 243 substantially the same as the rails 116, 118. Each panel 12, 14 has the pair of the movement sections 220, 222 attached to its top and bottom ends.

Each movement section 220, 222 comprises a rail attachment 236, a panel attachment 238, rollers 240, and part of the synchronization system 224 substantially the same as movement sections 120, 122.

The synchronization system comprises the motor 290, a rotatable shaft 246 extending from the motor 290, and a cog (or gear) 242 fixed to the end of the shaft 246. The motor 290 may be linked to an electronic drive and a synchronization box. However, any suitable configuration may be provided.

Horizontal movement of the panels 12, 14 along the rails 216, 218 is provided when the motor 290 is energized to rotate the shaft 246 clockwise or counter clockwise depending on the user's wish to move the panel 12, 14 forwards or backwards (along the length of the rail). When the motor 290 energized, the movement is transferred to the nut 282 through the engagement of the gears 242 and 243. Since the motor 290 is fixed to the gear box frame (or body) of the movement sections 220, 222 (best shown in FIG. 11), the panel 12, 14 moves when the motor 290 is activated (as the motor 290 drives the nut 282 along the threaded portions of the screw 280).

Similar to the rod 52 of the panel assembly 10 and the timing belt 185 of the panel system 100, the motor 290 provides different types of movement synchronizations (such as anti-tilting and rotation for example). The two motors 290 of each end of the panel 12, 14 are set to move in unison by means of an electrical system ensuring precise and equal rotation of both motors in the same instant. Since both ends of the panel 12, 14 are moving at the same speed and time and are displaced a substantially exact distance, there is no tilting observed. Additionally, the motor may be configured to provide synchronized rotational movement of the panels 12, 14. The motors 290 may provide motor synchronization of the panel system 200 in connection with an electronics circuit connected to a home automation system for example. However, any suitable motor configuration may be provided.

It should be understood that the foregoing description is only illustrative of the invention. Various alternatives and modifications can be devised by those skilled in the art without departing from the invention. Accordingly, the invention is intended to embrace all such alternatives, modifications and variances which fall within the scope of the appended claims.

What is claimed is:

1. A panel movement system comprising:
top and bottom rails comprising threaded screw members along their lengths and first cog members rotatively coupled to the threaded screw members;
top and bottom rail attachments movably attached to respective ones of the rails for lateral movement along lengths of the rails, wherein each rail attachment comprises a rotatable second cog member engaged with the first cog member on respective ones of the rails; and
a gear movement synchronization system connecting the rotatable second cog member of the top rail attachment to the rotatable second cog member of the bottom rail attachment such that the top and bottom rail attachments move along the rails in unison, wherein the top and bottom rail attachments are adapted to have a panel connected therebetween.

2. The panel movement system of claim 1 wherein the gear movement synchronization system comprises a timing belt connected between the rotatable second cog member of the top rail attachment and the rotatable second cog member of the bottom rail attachment.

3. The panel movement system of claim 2 wherein the gear movement synchronization system comprises the top and bottom rail attachments having intermediate gears connecting the second cog members to the timing belt.

4. The panel movement system of claim 1 wherein the gear movement synchronization system comprises a motor connected to the rotatable second cog member of the top rail attachment.

5. The panel movement system of claim 4 wherein the gear movement synchronization system comprises a motor connected to the rotatable second cog member of the bottom rail attachment.

6. The panel movement system of claim 1 wherein the top and bottom rails further comprise threaded nut members, wherein the first cog members are fixed to the threaded nut members, and wherein the threaded nut members are threadably engaged with the threaded screw members on respective ones of the rails.

7. The panel movement system of claim 1 wherein at least one of the rail attachments comprises a top roller and a bottom roller located on opposite sides of one of the rails.

8. The panel movement system of claim 1 wherein the first cog members and the second cog members are bevel gear members.

9. A panel movement system comprising:
a first rail comprising a threaded screw member and a first cog member, wherein the threaded screw member extends along a length of the first rail, and wherein the first cog member is rotatively coupled to the threaded screw member;
a first rail attachment movably attached to the first rail for lateral movement along the length of the first rail, wherein the first rail attachment comprises a rotatable second cog member engaged with the first cog member on the first rail; and
a gear movement synchronization system connected to the rotatable second cog member of the first rail attachment, wherein the first rail attachment is configured to be connected to a first side of a panel, and wherein the first rail attachment comprises a top and a bottom roller located on opposite sides of the first rail.

10. The panel movement system of claim 9 wherein the gear movement synchronization system further comprises a motor connected to the rotatable second cog member.

11. The panel movement system of claim 9 wherein the gear movement synchronization system further comprises a timing belt connected to the rotatable second cog member.

12. The panel movement system of claim 11 further comprising a second rail and a second rail attachment, wherein the timing belt is connected between the first rail attachment and the second rail attachment.

13. The panel movement system of claim 11 wherein a length of the timing belt is substantially perpendicular to the length of the first rail.

14. The panel movement system of claim 9 wherein the first rail further comprises a threaded nut member, wherein the first cog member is fixed to the threaded nut member, and wherein the threaded nut member is threadably engaged with the threaded screw member.

15. The panel movement system of claim 9 wherein the top and bottom rollers are rotatably connected to roller shafts, wherein the roller shafts are attached to a gearbox frame of the gear movement synchronization system, and wherein the threaded screw member extends between the roller shafts.

16. The panel movement system of claim 9 wherein the first cog member is configured to be movable along a length of the threaded screw member.

17. A method of manufacturing a movable panel system comprising:
connecting top and bottom movement systems to top and bottom ends of a panel, wherein the top and bottom movement systems each comprise a rotatable gear member;
connecting the movement systems to respective top and bottom rails such that the movement systems can traverse along the rails;
connecting threaded screw members adjacent to the top and bottom rails, wherein the threaded screw members extend along lengths of the rails;
rotatively coupling first cog members to the threaded screw members; and
engaging the rotatable gear members of the top and bottom movement systems with the first cog members, wherein the top and bottom movement systems operate in registration with each other and traverse along the rails in unison with each other.

18. The method of claim 17 further comprising connecting a timing belt between the top and bottom movement systems.

19. The method of claim 17 further comprising connecting a motor to at least one of the top and bottom movement systems.

20. The method of claim 17 further comprising providing top and bottom rollers on opposite sides of at least one of the top and bottom rails.
